(19) United States
(12) Patent Application Publication
(10) Pub. No.: US 2011/0228059 A1
(43) Pub. Date: Sep. 22, 2011

(54) PARALLAX AMOUNT DETERMINATION DEVICE FOR STEREOSCOPIC IMAGE DISPLAY APPARATUS AND OPERATION CONTROL METHOD THEREOF

(76) Inventor: Norio NAGAI, Saitama-shi (JP)

(21) Appl. No.: 13/030,424

(22) Filed: Feb. 18, 2011

(30) Foreign Application Priority Data
Mar. 16, 2010 (JP) P2010-059338

(51) Int. Cl. H04N 13/04

(52) U.S. Cl. 348/54; 348/E13.075

(57) ABSTRACT

A parallax appropriate for a viewer is determined. An iris-to-iris distance of a user is stored for each user. A viewer at the front of the display screen of a stereoscopic image display apparatus is photographed, and an iris image of the viewer is detected. Iris authentication is carried out, and if the same image as the detected iris image is stored, it is understood which user is the viewer. The iris-to-iris distance of the viewer is read. A parallax is determined from the read iris-to-iris distance, the distance from the display screen to the viewer, and the display screen size.

### BACKGROUND OF THE INVENTION

1. Field of the Invention

The present invention relates to a parallax amount determination device for a stereoscopic image display apparatus and an operation control method thereof.

2. Description of the Related Art

In a display device which displays a stereoscopic image, there is a parallax between a left-eye image viewed by the left eye of the viewer and a right-eye image viewed by the right eye of the viewer. Although a parallax amount is determined depending on images, not every viewer can view a stereoscopic image. For this reason, a display device is known which adjusts a parallax amount (JP2004-333661A, JP2003-329972A, and JP2001-339741A).

However, JP2004-333661A, JP2003-329972A, and JP2001-339741A in the first place do not describe a case at all where a stereoscopic image is viewed by a number of people inherently. Given this, when a number of people view a stereoscopic image, the parallax amount may become inappropriate for most of the people, and many viewers may not sufficiently view the stereoscopic image in stereoscopic view. A parallax amount may not be appropriate for a specific viewer or a specific viewer group, and a desired viewer or viewer group may not sufficiently view a stereoscopic image in stereoscopic view. These problems become noticeable with an increase in size of a device which displays a stereoscopic image.

### SUMMARY OF THE INVENTION

Accordingly, an object of the invention is to appropriately calculate and adjust a parallax amount for most of the viewers when a number of people view a stereoscopic image such that most of the viewers can sufficiently view the stereoscopic image in stereoscopic view. Another object of the invention is to calculate and adjust a parallax amount appropriate for a specific viewer or a specific viewer group such that a desired viewer or viewer group can sufficiently view a stereoscopic image in stereoscopic view.

In order to achieve the above-described objects, the invention provides a parallax amount determination device for a stereoscopic image display apparatus which determines a parallax amount of a stereoscopic image display apparatus displaying a stereoscopic image. The device includes an iris imaging unit which captures an image of an iris of at least one viewer of a stereoscopic image and outputs iris image data representing an iris image, a viewer determination unit which determines a viewer of the stereoscopic image from iris authentication information of a storage device, in which user information, iris authentication information, and the center-to-center distance between the center of a left eye and the center of a right eye are stored in association with each other, on the basis of iris image data output from the iris imaging unit, a distance measurement unit which measures the distance from the display screen of the stereoscopic image display apparatus to the viewer, a center-to-center distance measurement unit which measures a center-to-center distance of the viewer, a first determination unit which determines whether or not the center-to-center distance of the viewer is stored in the storage device on the basis of the iris image represented by iris image data output from the iris imaging unit, a center-to-center distance reading unit which, when the first determination unit determines that the center-to-center distance of the viewer is stored in the storage device, reads the center-to-center distance of the viewer determined by the viewer determination unit from the storage device, and a parallax amount determination unit which determines a parallax amount from the distance to the viewer measured by the distance measurement unit and the center-to-center distance read by the center-to-center distance reading unit or when the first determination unit determines that the center-to-center distance of the viewer is not stored in the storage device, determines a parallax amount from the shortest distance from among the distances to the viewer measured by the distance measurement unit and the center-to-center distance measured by the center-to-center distance measurement unit for a viewer at the shortest distance.

The invention also provides an operation control method suitable for a parallax amount determination device for a stereoscopic image display apparatus. That is, the invention provides an operation control method of a parallax amount determination device which determines a parallax amount of a stereoscopic image display apparatus which displays a stereoscopic image. The method includes the steps of causing an iris imaging unit to capture an image of an iris of a viewer of a stereoscopic image and to output iris image data representing an iris image, causing a viewer determination unit to determine a viewer of the stereoscopic image from iris authentication information of a storage device, in which user information, iris authentication information, and the center-to-center distance between the center of a left eye and the center of a right eye are stored in association with each other, on the basis of iris image data output from the iris imaging unit, causing a distance measurement unit to determine the distance from the display screen of the stereoscopic image display apparatus to the viewer, causing a center-to-center distance measurement unit to measure the center-to-center distance of the viewer, causing a determination unit to determine whether or not the center-to-center distance of the viewer is stored in the storage device on the basis of an iris image represented by iris image data output from the iris imaging unit, causing a center-to-center distance reading unit to read the center-to-center distance of the viewer determined by the viewer determination unit from the storage device when the first determination unit determines that the center-to-center distance of the viewer is stored in the storage device, and causing a parallax amount determination unit to determine a parallax amount from the display screen size of the stereoscopic image display apparatus, the distance to the viewer measured by the distance measurement unit, and the center-to-center distance read by the center-to-center distance reading unit or when the first determination unit determines that the center-to-center distance of the viewer is not stored in the storage device, to determine a parallax amount from the display screen size of the stereoscopic image display apparatus, the shortest distance from among the distances to the viewer measured by the distance measurement unit, and the center-to-center distance measured by the center-to-center distance measurement unit for the viewer at the shortest distance.

According to the invention, the distance to the viewer of the stereoscopic image display apparatus is measured. The image of the iris of the viewer is captured, and it is determined whether or not the center-to-center distance between the center of the left eye and the center of the right eye of the viewer is stored in the storage device on the basis of the captured iris image. If the center-to-center distance of the viewer is stored in the storage device, the parallax amount is determined from the distance to the viewer and the stored center-to-center distance of the viewer. If the center-to-center distance of the viewer is not stored in the storage device, the parallax amount is determined from the shortest distance from among the distances to the viewer measured by the distance measurement unit and the center-to-center distance measured by the center-to-center distance measurement unit for the viewer at the shortest distance.

From the viewpoint of further increasing accuracy, it is preferable that the parallax amount is determined from the display screen size of the stereoscopic image display apparatus as well as the distance to the viewer measured by the distance measurement unit and the center-to-center distance read by the center-to-center distance reading unit. Thus, the parallax amount is determined in consideration of the display screen size of the stereoscopic image display apparatus and the distance to the viewer as well as the center-to-center distance between the center of the left eye and the center of the right eye of the viewer, making it possible to more accurately determine the parallax amount.

The center-to-center distance may substantially represent the distance between the center of the left eye and the center of the right eye, and includes the distance between the iris of the left eye and the iris of the right eye, the distance between the pupil of the left eye and the pupil of the right eye, the distance between the tail of one eye and the rim of the other eye, and the like.

The device may further include an average distance calculation unit which, when the first determination unit determines that the center-to-center distance of the viewer is not stored in the storage device, calculates an average distance of the distances to at least one viewer measured by the distance measurement unit. In this case, the parallax amount determination unit determines the parallax amount, for example, from the display screen size of the stereoscopic image display apparatus, the average distance calculated by the average distance calculation unit, and the predetermined center-to-center distance.

The device may further include a blink time measurement unit which measures the blink time (the time for which the eye is closed by blinking) of the viewer, a second determination unit which determines whether or not the blink time measured by the blink time measurement unit is equal to or longer than a predetermined time, and a first correction unit which, when the second determination unit determines that the blink time is equal to or longer than the predetermined time, corrects the parallax amount determined by the parallax amount determination unit.

The device may further include a first number-of-blinks measurement unit which measures the number of blinks (the number of repetitions of continuous opening/closing of the eye at an interval shorter than a predetermined time) of the viewer, a third determination unit which determines whether or not the number of blinks measured by the first number-of-blinks measurement unit is equal to or greater than a predetermined number of times, and a second correction unit which, when the third determination unit determines that the number of blinks is equal to or greater than the predetermined number of times, corrects the parallax amount determined by the parallax amount determination unit.

The device may further include a second number-of-blinks measurement unit which measures the number of blinks of each of the left and right eyes of the viewer, a fourth determination unit which determines whether or not the number of blinks of the right eye or the number of blinks of the left eye measured by the second number-of-blinks measurement unit is equal to or greater than a predetermined number of times, and a third correction unit which, when the fourth determination unit determines that the number of blinks of the left eye or the number of blinks of the right eye is equal to or greater than the predetermined number of times, if the number of blinks of one of the left and right eyes is greater than the number of blinks of the other eye, corrects the parallax amount determined by the parallax amount determination unit so as to increase the parallax amount, and if the number of blinks of the other eye is greater than the number of blinks of the one eye, corrects the parallax amount determined by the parallax amount determination unit so as to decrease the parallax amount.

The device may further include a viewer presence/absence determination unit which determines whether or not the viewer whose center-to-center distance is stored as the determination result of the first determination unit disappears from the front of the display screen of the stereoscopic image display apparatus, and a fifth determination unit which, when the viewer presence/absence determination unit determines that the viewer disappears from the front of the display screen of the stereoscopic image display apparatus, determines whether to determine the parallax amount by using the shortest distance from among the distances to another viewer other than the viewer who disappears from the display screen of the stereoscopic image display apparatus or to determine the parallax amount by using an average distance of the distances to another viewer other than the viewer who disappears from the display screen of the stereoscopic image display apparatus. In this case, for example, the parallax amount determination unit determines the parallax amount, for example, from the display screen size of the stereoscopic image display apparatus, the shortest distance to the viewer measured by the distance measurement unit, and the center-to-center distance measured by the center-to-center distance measurement unit for the viewer at the shortest distance when the fifth determination unit determines to determine the parallax amount by using the shortest distance and determines the parallax amount, for example, from the display screen size of the stereoscopic image display apparatus, the average distance to another viewer calculated by the average distance calculation unit, and a predetermined center-to-center distance when the fifth determination unit determines to determine the parallax amount by using the average distance.

The device may further include a parallax amount switching unit which switches the parallax amount of the stereoscopic image to the determined parallax amount in synchronization with a timing for switching contents displayed on the display screen of the stereoscopic image display apparatus.

### BRIEF DESCRIPTION OF THE DRAWINGS

FIG. 1 is a block diagram showing the electrical configuration of a stereoscopic image display apparatus.

FIG. 2 shows a user/iris information table.

FIG. 3 shows a relationship between a parallax amount and a distance from a display screen or the like.

FIG. 4 is a flowchart of a procedure of parallax adjustment processing for a viewer.

FIG. 5 is a flowchart of a procedure of parallax adjustment processing for a viewer.

FIG. 6 shows a relationship between a parallax amount and a distance from a display screen or the like.

FIG. 7 shows a relationship between a parallax amount and a distance from a display screen or the like.

FIG. 8 is a flowchart of a procedure of parallax adjustment processing for a viewer.

FIG. 9 is a flowchart of a procedure of parallax adjustment processing for a viewer.

FIG. 10 is a flowchart of a procedure of parallax amount correction processing.

FIG. 11 is a flowchart of a procedure of parallax amount correction processing.

FIG. 12 is a flowchart of a procedure of parallax amount correction processing.

### DESCRIPTION OF THE PREFERRED EMBODIMENTS

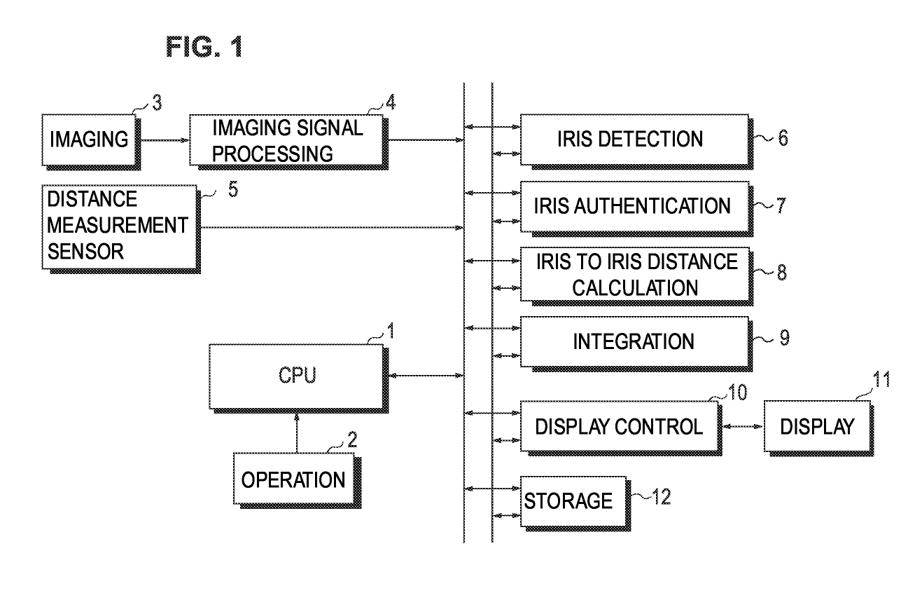

FIG. 1 shows an example of the invention and is a block diagram showing the electrical configuration of a stereoscopic image display apparatus.

The overall operation of the stereoscopic image display apparatus is controlled by a CPU. The stereoscopic image display apparatus includes an operation device 2 which is used to input a command from a viewer or the like. An operation signal which is output from the operation device 2 is input to a CPU 1.

The stereoscopic image display apparatus includes a storage device 12. Motion image data which is stored in the storage device 12 is provided to a display device 11 under the control of a display control device 10, such that a stereoscopic motion image (or still image) is displayed on the display device 11. A left-eye image and a right-eye image are displayed on the display device 11, and the viewer of the stereoscopic image display apparatus views the left-eye image with his/her left eye and views the right-eye image with his/her right eye, such that the viewer can view a stereoscopic image.

In this example, an iris image representing the iris of each of multiple users is stored in the storage device 12 in advance. The iris-to-iris distance of each user is stored in the storage device 12.

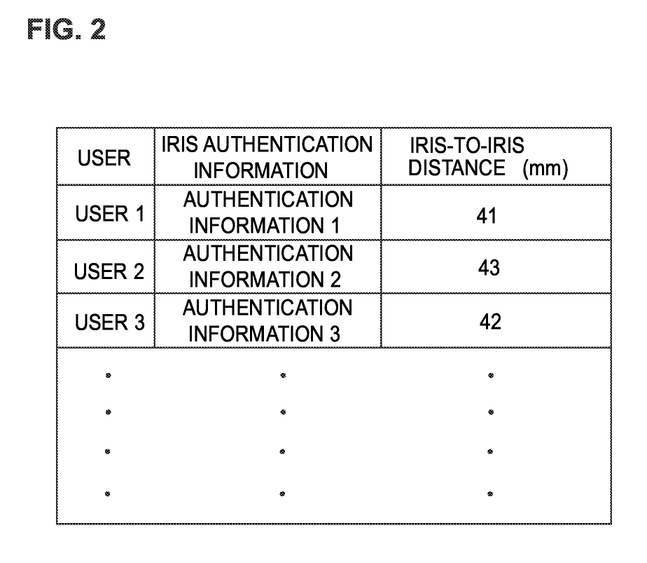

FIG. 2 shows an example of a user/iris information table which is stored in the storage device 12.

The user/iris information table stores iris authentication information and the iris-to-iris distance of each user. The iris authentication information is information for iris authentication (specification) and includes an iris code obtained by coding iris information, an iris image, and the like. As described above, if the image of the iris of the viewer of the stereoscopic image display apparatus is captured to obtain an iris image, iris authentication information corresponding to the iris image is detected from the user/iris information table. Which user is the viewer is found from the detected iris authentication information, and the iris-to-iris distance of the viewer is found. For example, if the captured iris image corresponds to iris authentication information 1, it is found that the viewer is a user 1, and the iris-to-iris distance of the user is 41 mm. In this way, the iris-to-iris distance of the user is found from the iris image. Although in FIG. 2, the iris-to-iris distance is stored in the table, it should suffice that there is no iris-to-iris distance, and data for substantially finding the center-to-center distance between the center of the left eye and the center of the right eye of the user is stored. For example, instead of the iris-to-iris distance, the center-to-center distance, the distance between the pupil of the left eye and the pupil of the right eye, the distance between the tail of one eye and the rim of the other eye, or the like may be stored.

In this example, data representing a parallax amount appropriate for each user is also stored in the storage device 12.

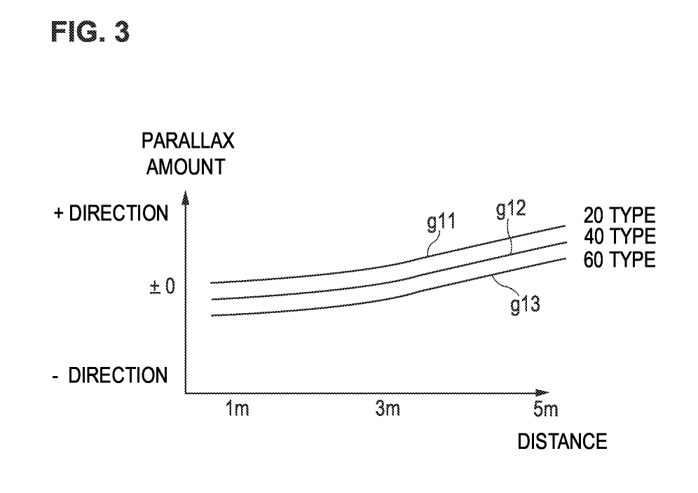

FIG. 3 shows a relationship between the parallax amount of the user 1, the distance to the display screen, and the display screen size of the stereoscopic image display apparatus.

The vertical axis represents a parallax amount (a parallax between a left-eye image and a right-eye image), and the horizontal axis represents the distance from the display screen of the stereoscopic image display apparatus to the viewer. A graph g11 shows the relationship between the parallax amount and the distance from the display screen to the viewer when the display screen of the stereoscopic image display apparatus is of 20 type. Similarly, graphs g12 and g13 respectively show the relationship between the parallax amount and the distance from the display screen to the viewer when the display screen is of 40 type and 60 type. Although a case has been described where the display screen is of 20 type, 40 type, and 60 type, other sizes are of course defined.

Data representing such a relationship is stored in the storage device 12 for each user. If it is specified which user is the viewer who is viewing a stereoscopic image displayed on the stereoscopic image display apparatus, data shown in FIG. 3 corresponding to the specified user is read. An optimum parallax amount for the specified user is determined from the size of the display screen which is viewed by the specified user and the distance from the display screen to the specified user.

The parallax amount of the user is determined in consideration of the iris-to-iris distance of the user, the display screen size, and the distance to the display screen. Thus, it is understood that an optimum parallax amount for the user can be determined.

Returning to FIG. 1, the stereoscopic image display apparatus includes an imaging device 3. The imaging device 3 captures the image of a user (iris, eye, entire body including eye, face) who is viewing a stereoscopic image at the front of the display screen of the stereoscopic image display apparatus. Image data output from the imaging device 3 is input to an imaging signal processing device 4. In the imaging signal processing device 4, predetermined signal processing is performed.

Image data output from the imaging signal processing device 4 is input to an iris detection device 6, and an iris image is detected. Image data representing the detected iris image is input to an iris authentication device 7. The imaging device 3 may capture the image of the iris of the user and data representing the captured iris image may be input to the iris authentication device 7. In the iris authentication device 7, it is determined whether or not iris image data corresponding to the captured iris image is stored in the storage device 12. If iris image data corresponding to the captured iris image is stored in the storage device 12, a user of an iris image represented by stored iris image data is determined. The iris-to-iris distance of the determined user is detected from the table shown in FIG. 2.

The stereoscopic image display apparatus is also provided with a distance measurement sensor 5. The distance measurement sensor 5 measures the distance to a viewer at the front of the display screen of the stereoscopic image display apparatus. In the case of a single viewer, data representing the distance to the single viewer is output from the distance measurement sensor 5. In the case of multiple viewers, data representing the distance to each of the multiple viewers is output from the distance measurement sensor 5. Data representing the distance output from the distance measurement sensor 5 is input to an integration device 9, and the distance to the viewer is calculated. In measuring the distance of each of the multiple viewers, if necessary, a plurality of distance measurement sensors 5 are provided. A single distance measurement sensor 5 may be used to measure the distance of each of the multiple viewers.

The stereoscopic image display apparatus also includes an iris-to-iris distance calculation device 8. Image data of the image-captured viewer is input to the iris-to-iris distance calculation device 8, such that the iris-to-iris distance of the viewer is calculated.

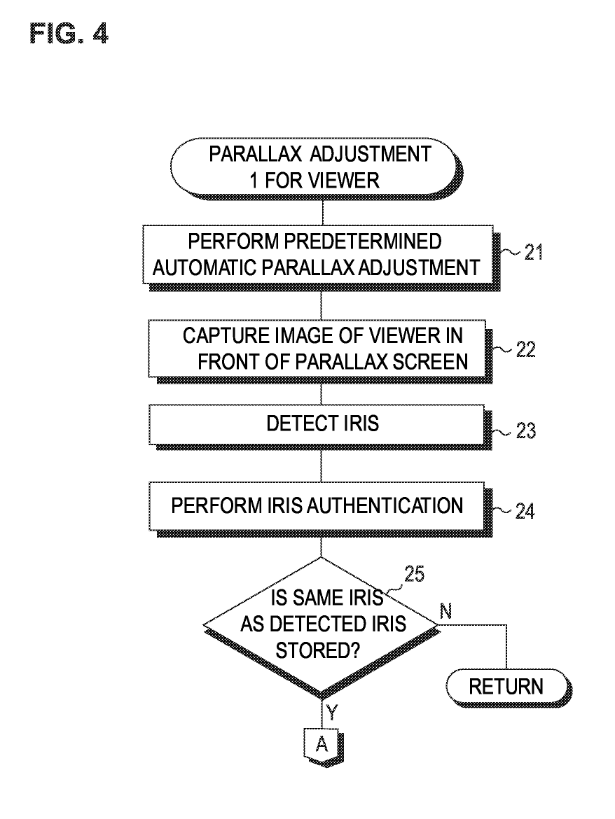

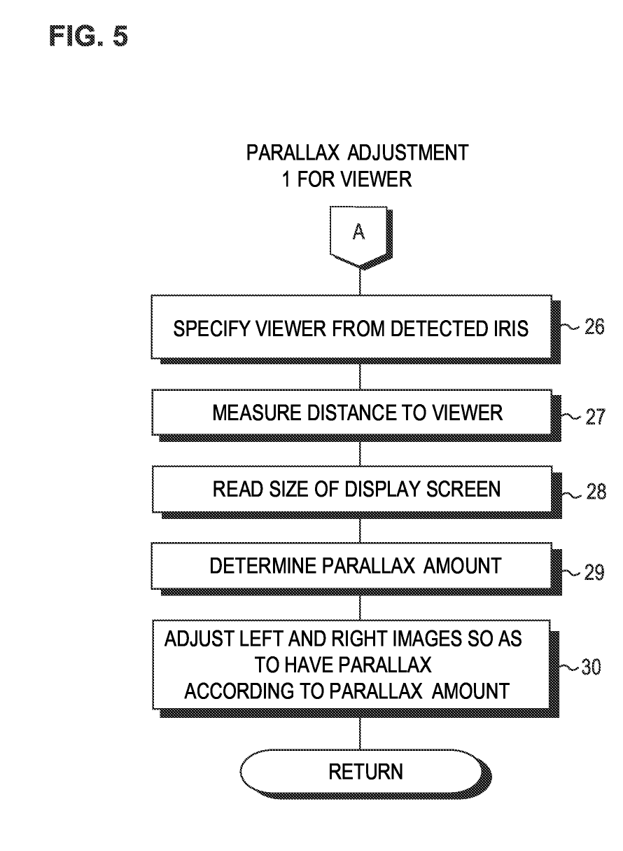

FIGS. 4 and 5 are flowcharts showing a procedure of parallax adjustment processing for a viewer.

First, predetermined automatic parallax adjustment defined in advance is carried out (Step 21). Thereafter, the imaging device 3 captures the image of a viewer at the front of the display screen of the stereoscopic image display apparatus (Step 22). As described above, image data obtained by capturing the image of the viewer is input to the iris detection device 6, and an iris image is detected (Step 23).

If an iris image is detected, iris authentication is carried out (Step 24), and it is determined whether or not an iris code corresponding to the detected iris image is stored in the storage device 12 (Step 25). Of course, when iris image data as well as an iris code is stored in the storage device, it is determined whether or not iris image data corresponding to the detected iris image is stored. Determination on whether or not image data representing the iris image of the image-captured viewer is stored in the storage device 12 is equivalent to determination on whether or not the iris-to-iris distance of the image-captured viewer is stored in the storage device 12.

If image data representing the same iris image as the detected iris image is stored in the storage device 12 (YES in Step 25), it is specified which user from among the stored users the viewer is from the detected iris image (Step 26). The distance to the viewer is measured (Step 27). Data representing the size of the display screen of the stereoscopic image is read from the storage device 12 (Step 28).

For the specified user, data representing the relationship between the parallax amount, the distance to the display screen, and the display screen size shown in FIG. 3 is read from the storage device, and a parallax amount appropriate for the specified user is determined on the basis of the relationship represented by read data (Step 29). The parallax between the left-eye image and the right-eye image (left and right images) is adjusted so as to coincide with the determined parallax amount (Step 30).

In the above-described example, when multiple viewers are present and the iris images of multiple viewers are stored, the parallax amount may be determined on the basis of the iris of any viewer.

Although in the above-described example, a case has been described where a user is determined from an iris image, and an iris-to-iris distance is detected from the determined user, an iris image and an iris-to-iris distance may be stored so as to have a one-to-one correspondence relationship, and the iris-to-iris distance may be detected without determining a user from the detected iris image.

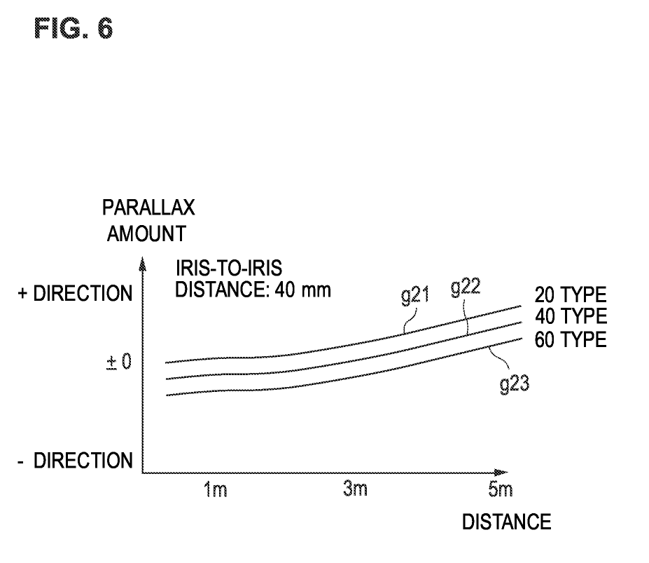

FIGS. 6 to 8 show another example. This example shows processing when multiple viewers are present, and it is assumed that, when the same iris image as the detected iris image is not stored, a parallax appropriate for a viewer closest to the display screen is determined.

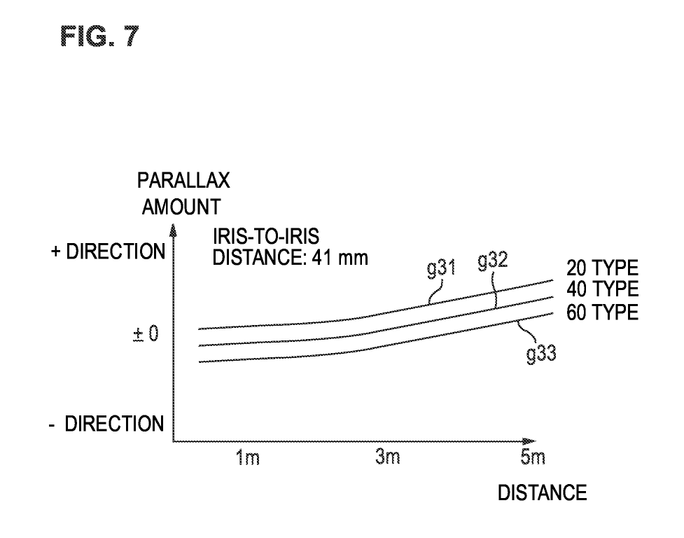

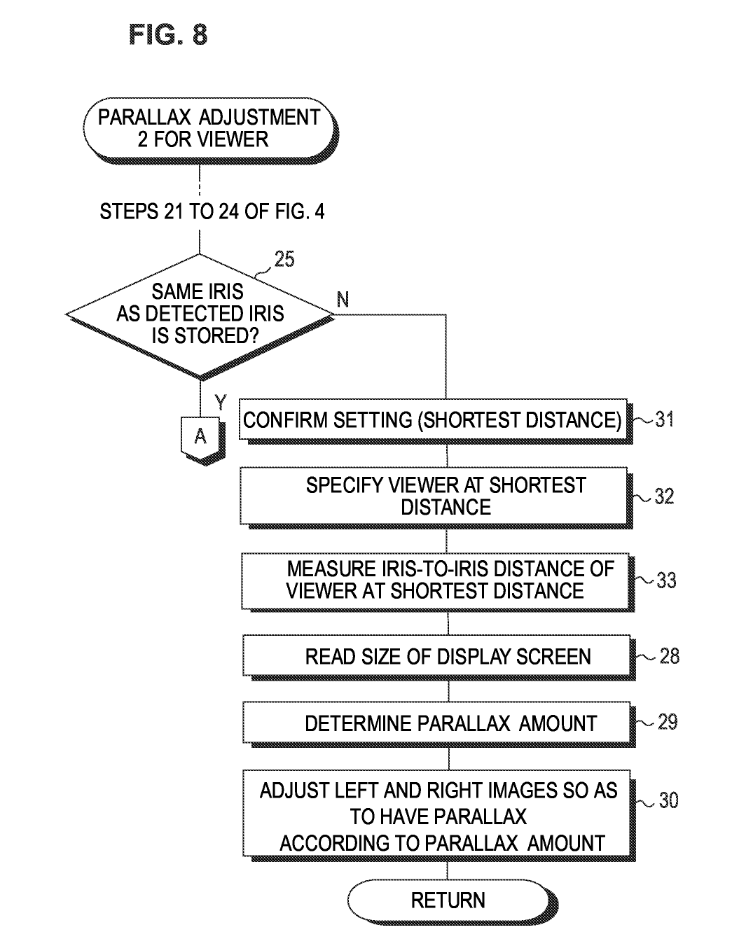

FIGS. 6 and 7 correspond to FIG. 2, and show the relationship between the parallax amount, the distance to the display screen, and the display screen size. FIG. 7 is appropriate for a viewer whose iris-to-iris distance is 40 mm, and FIG. 8 is appropriate for a viewer whose iris-to-iris distance is 41 mm. Although a case has been described where the iris-to-iris distance is 40 mm and 41 mm, data regarding an iris-to-iris distance in a range of 40 mm to 90 mm which differs by 1 mm is stored in the storage device 12. An iris-to-iris distance smaller than 40 mm or an iris-to-iris distance greater than 90 mm may be stored. In FIG. 6, graphs g21, g22, and g23 respectively show when the display screen is of 20 type, 40 type, and 60 type. In FIG. 7, graphs g31, g32, and g33 respectively show when the display screen is of 20 type, 40 type, and 60 type.

FIG. 8 is a flowchart showing a procedure of parallax adjustment processing for a viewer. In FIG. 8, the same steps as those in FIG. 4 or 5 are represented by the same reference numerals, and description thereof will be omitted.

First, the same processing as in Steps 21 to 25 of FIG. 4 is performed. When the same iris image as the detected iris image is stored (YES in Step 25), the processing of Steps 26 to 30 of FIG. 5 is performed.

When the same iris image as the detected iris image is not stored (NO in Step 25), it is confirmed how processing is set which is performed when the same iris image as the detected iris image is not stored (Step 31). In the example of FIG. 8, it is assumed that a setting is made such that a parallax is adjusted so as to be appropriate for a viewer closest to the display screen (shortest distance setting) (Step 31). This setting is of course carried out in advance by using the operation device 2.

As described above, since an image of a viewer at the front of the display screen is captured, a viewer at the shortest distance from the display screen is specified from the image (Step 32). The viewer at the shortest distance may be a person having the greatest ratio of the face in the image or may be determined on the basis of the actually measured distance. The iris-to-iris distance of the viewer is measured from the image of the viewer at the shortest distance (Step 33).

A parallax amount appropriate for the viewer at the shortest distance is determined from data representing the relationship corresponding to the measured iris-to-iris distance from among the relationship between the parallax amount, the distance to the display screen, and the display screen size shown in FIGS. 6 and 7 (Steps 28 and 29). The left and right images are adjusted so as to have the determined parallax amount (Step 30).

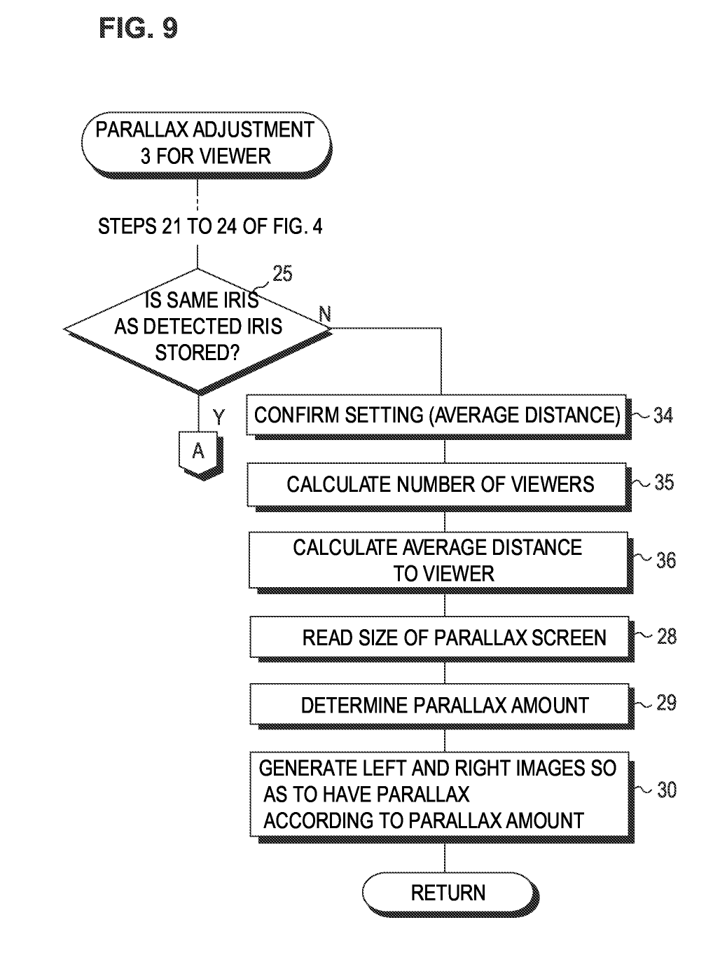

FIG. 9 shows yet another example and is a flowchart showing a procedure of parallax adjustment processing for a viewer. In FIG. 9, the same steps as those in FIGS. 4, 5, and 8 are represented by the same reference numerals, and description thereof will be omitted.

When the same iris image as the detected iris image is not stored (NO in Step 25), it is confirmed how processing is set which is performed when the same iris image as the detected iris image is not stored (Step 34). In the example of FIG. 9, it is assumed that a setting is made such that a parallax is adjusted by using the average distance of the distances from the display screen to viewers at the front of the display screen (average distance setting) (Step 34). This setting is of course carried out in advance by using the operation device 2.

As described above, since an image of viewers at the front of the display screen is captured, the number of viewers at the front of the display screen is calculated from the image (Step 35). The average distance of the distances to the viewers at the front of the display screen is measured (Step 36).

A parallax amount appropriate for when a viewer is at the average distance is determined from data representing the relationship corresponding to a predetermined iris-to-iris distance from among the relationship between the parallax amount, the distance to the display screen, and the display screen size shown in FIGS. 6 and 7 (Steps 28 and 29). The left and right images are adjusted so as to have the determined parallax amount (Step 30).

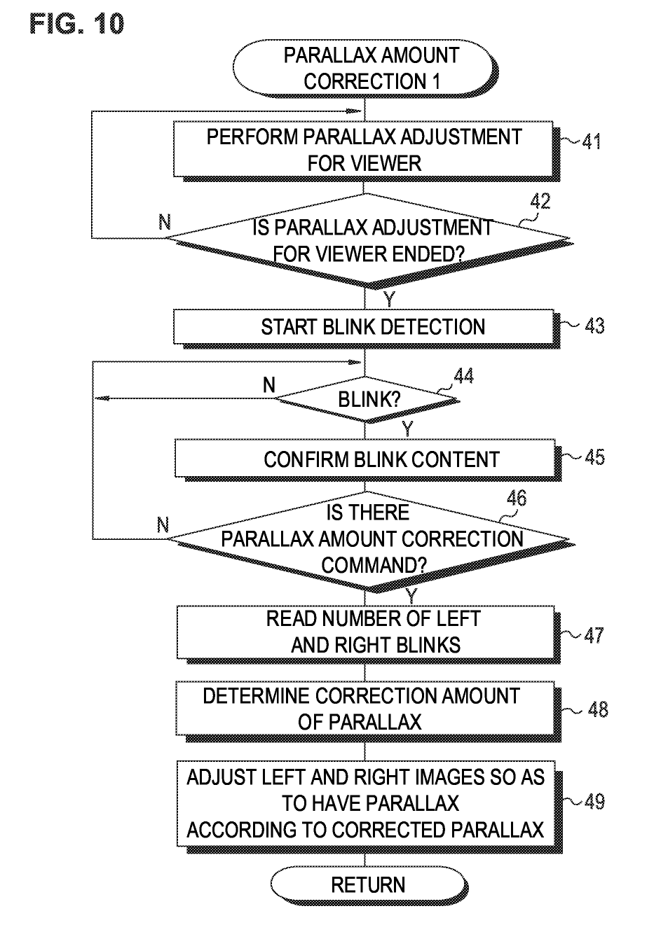

FIG. 10 is a flowchart showing a procedure of parallax amount correction processing. The parallax amount correction processing is performed for correcting the parallax amount determined in the above-described manner.

Parallax adjustment is carried out by the method shown in FIGS. 4 and 5, 8, or 9 (Step 41). If parallax adjustment ends (YES in Step 42), blink detection processing starts (Step 43).

If a blink is detected (YES in Step 44), the content of the blink is confirmed (Step 45). For example, it is confirmed whether or not a blink is a real blink, whether a blink is a left-eye blink or a right-eye blink, or the like. If it is found that a blink is a true blink, the number of blinks is counted for each of the left and right eyes. A blink time is incremented. Until there is a parallax amount correction command, the processing in Steps 44 and 45 is repeated (Step 46).

If there is a parallax amount correction command (YES in Step 46), the number of blinks and the blink time of each of the left and right eyes are read (Step 47). A correction amount of the parallax amount is determined on the basis of the read number of blinks and blink time (Step 48). A parallax is corrected with the determined correction amount, and the left and right images are adjusted on the basis of the corrected parallax (Step 49).

For example, if the number of blinks (the number of blinks of the left eye or right eye or the number of blinks of both eyes) is equal to or greater than a predetermined threshold value regardless of the left eye and the right eye (a device is provided to determined whether or not the number of blinks is equal to or greater than a predetermined threshold value), it is considered that a parallax is inappropriate for a viewer, and the parallax is corrected. Correction may be carried out so as to increase the parallax or to decrease the parallax. It is considered that, even when the total blink time is equal to or longer than a predetermined time, the parallax is inappropriate for the viewer, thus the parallax is corrected (a device is provided to determined whether or not the total blink time is equal to or longer than a predetermined time). When the number of blinks of the right eye or the number of blinks of the left eye is equal to or greater than a predetermined number of times and when the number of blinks of the right eye is greater than the number of blinks of the left eye, the parallax amount may increase, and when the number of blinks of the left eye is greater than the number of blinks of the right eye, the parallax amount may decrease (a number-of-blinks comparison device is provided).

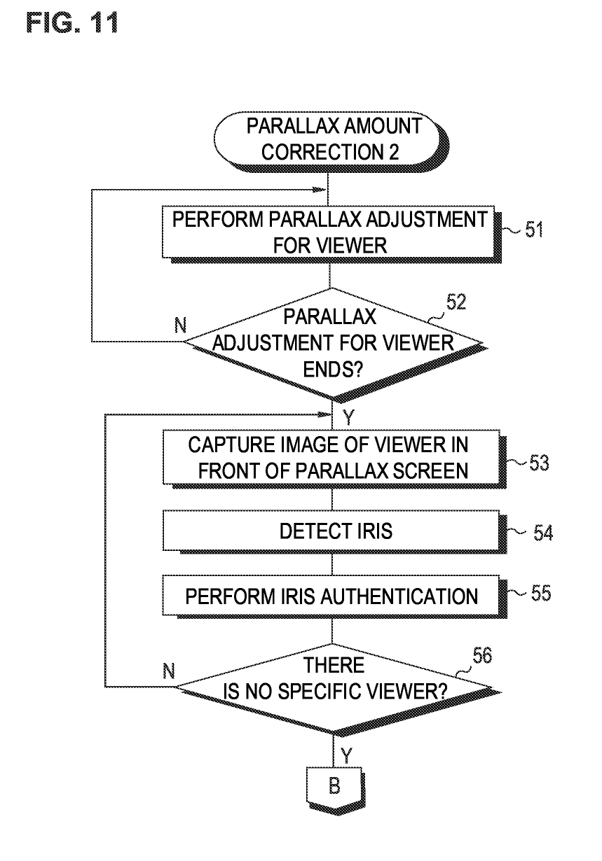

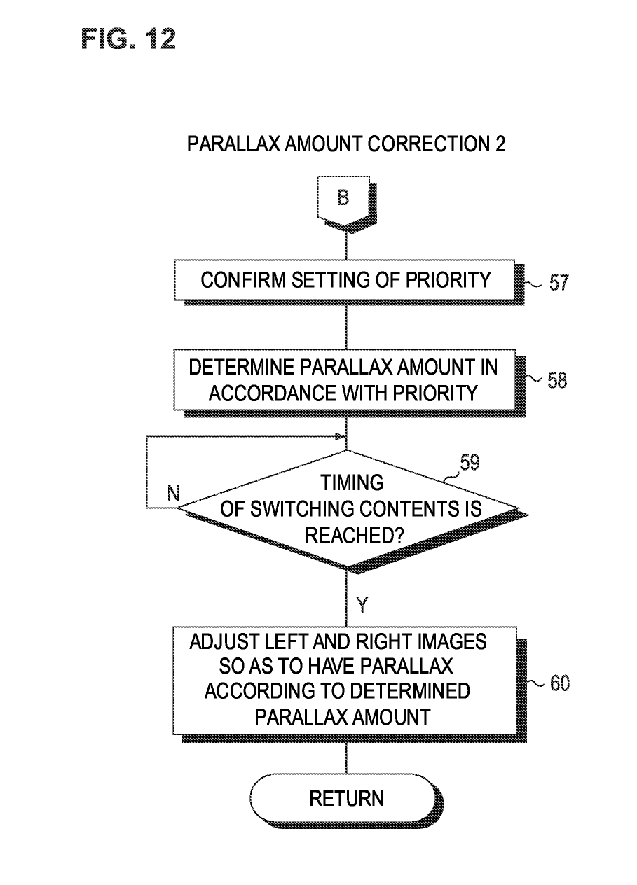

FIGS. 11 and 12 show another example and is a flowchart showing a procedure of parallax amount correction processing.

Parallax adjustment is carried out by the method shown in FIGS. 4 and 5, 8, or 9 (Step 41). If parallax adjustment ends (YES in Step 42), blink detection processing starts (Step 43).

An image of a viewer at the front of the display screen is captured (Step 53), and the iris image of the image-captured viewer is detected (Step 54). Iris authentication is carried out from the detected iris image in the above-described manner (Step 55). If a user whose iris image is stored is confirmed through iris authentication, it is found which user is present at the front of the display screen, thus it is confirmed whether or not a specific viewer whose parallax is appropriately adjusted through parallax adjustment for a viewer disappears from the front of the display screen (Step 56). If a specific viewer is at the front of the display screen (NO in Step 56), the processing in Steps 53 to 55 is repeated.

It is determined whether or not a specific viewer disappears from the front of the display screen (Step 56). For example, when an image of a specific viewer is captured and the iris, eye, face, or the like of the viewer is determined for equal to or longer than a predetermined time, it is determined that a specific viewer disappears from the display screen. If a specific viewer disappears from the front of the display screen (YES in Step 56), the setting of priority is confirmed (a priority determination device is provided and the priority is set in advance by the priority determination device) (Step 57). The parallax amount is determined depending on the priority (Step 58). As described above, if the priority is set as the shortest distance, a parallax is determined so as to be appropriate for a viewer closest to the display screen from among the viewers at the front of the display screen. As described above, if the priority is set as the average distance, a parallax amount is determined on the basis of the average distance from the display screen of the viewers at the front of the display screen.

If a timing for switching contents displayed on the display screen is reached (YES in Step 59), the left and right images are adjusted so as to have a parallax amount newly determined by a parallax amount switching unit (Step 60). In this way, the timing for switching contents using the parallax amount switching unit is synchronized with a timing for switching the left and right images having the newly determined parallax amount, making it possible for the user to view stereoscopy without feeding discomfort. The term “contents switching timing” used herein refers to the timing at which an image on the display screen is changed. Specifically, for example, the contents switching timing refers to a timing for switching images at the time of slide show of a still image, a timing for switching channels of a television, a timing for switching television commercial, a timing for switching television programs and television commercial, a timing for switching scenes of a motion image, a timing for switching camerawork of television programs, or the like.

Although in the foregoing examples, a parallax amount is determined depending on the priority set in advance, the priority may be determined each time the parallax amount is determined. For example, when a difference in the distance from the display screen between the viewers is small, the average distance may be used, and when the distance difference is great, the distance to a viewer at the closest position may be used. Information regarding children or adult may be stored in the user/iris information table, and if it is found that a viewer is children, the distance to the children may be used. In this way, the priority may be determined in accordance with the situation of the scene.

What is claimed is:

1. A parallax amount determination device for a stereoscopic image display apparatus which determines a parallax amount of a stereoscopic image display apparatus displaying a stereoscopic image, the device comprising:
an iris imaging unit which captures an image of an iris of at least one viewer of a stereoscopic image and outputs iris image data representing an iris image;
a viewer determination unit which determines a viewer of the stereoscopic image from iris authentication information of a storage device, in which user information, iris authentication information, and the center-to-center distance between the center of a left eye and the center of a right eye are stored in association with each other, on the basis of iris image data output from the iris imaging unit;
a distance measurement unit which measures the distance from the display screen of the stereoscopic image display apparatus to the viewer;
a center-to-center distance measurement unit which measures a center-to-center distance of the viewer;
a first determination unit which determines whether or not the center-to-center distance of the viewer is stored in the storage device on the basis of the iris image represented by iris image data output from the iris imaging unit;
a center-to-center distance reading unit which, when the first determination unit determines that the center-to-center distance of the viewer is stored in the storage device, reads the center-to-center distance of the viewer determined by the viewer determination unit from the storage device; and
a parallax amount determination unit which determines a parallax amount from the distance to the viewer measured by the distance measurement unit and the center-to-center distance read by the center-to-center distance reading unit or when the first determination unit determines that the center-to-center distance of the viewer is not stored in the storage device, determines a parallax amount from the shortest distance from among the distances to the viewer measured by the distance measurement unit and the center-to-center distance measured by the center-to-center distance measurement unit for a viewer at the shortest distance.

2. The device according to claim 1,
wherein the parallax amount is determined from the display screen size of the stereoscopic image display apparatus, the distance to the viewer measured by the distance measurement unit, and the center-to-center distance read by the center-to-center distance reading unit.

3. The device according to claim 1, further comprising:
an average distance calculation unit which, when the first determination unit determines that the center-to-center distance of the viewer is not stored in the storage device, calculates an average distance of the distances to at least one viewer measured by the distance measurement unit.

4. The device according to claim 2, further comprising:
an average distance calculation unit which, when the first determination unit determines that the center-to-center distance of the viewer is not stored in the storage device, calculates an average distance of the distances to at least one viewer measured by the distance measurement unit.

5. The device according to claim 1, further comprising:
a blink time measurement unit which measures the blink time of the viewer;
a second determination unit which determines whether or not the blink time measured by the blink time measurement unit is equal to or longer than a predetermined time; and
a first correction unit which, when the second determination unit determines that the blink time is equal to or longer than the predetermined time, corrects the parallax amount determined by the parallax amount determination unit.

6. The device according to claim 2, further comprising:
a blink time measurement unit which measures the blink time of the viewer;
a second determination unit which determines whether or not the blink time measured by the blink time measurement unit is equal to or longer than a predetermined time; and
a first correction unit which, when the second determination unit determines that the blink time is equal to or longer than the predetermined time, corrects the parallax amount determined by the parallax amount determination unit.

7. The device according to claim 1, further comprising:
a first number-of-blinks measurement unit which measures the number of blinks of the viewer;
a third determination unit which determines whether or not the number of blinks measured by the first number-of-blinks measurement unit is equal to or greater than a predetermined number of times; and
a second correction unit which, when the third determination unit determines that the number of blinks is equal to or greater than the predetermined number of times, corrects the parallax amount determined by the parallax amount determination unit.

8. The device according to claim 2, further comprising:
a first number-of-blinks measurement unit which measures the number of blinks of the viewer;
a third determination unit which determines whether or not the number of blinks measured by the first number-of-blinks measurement unit is equal to or greater than a predetermined number of times; and
a second correction unit which, when the third determination unit determines that the number of blinks is equal to or greater than the predetermined number of times, corrects the parallax amount determined by the parallax amount determination unit.

9. The device according to claim 1, further comprising:
a second number-of-blinks measurement unit which measures the number of blinks of each of the left and right eyes of the viewer;
a fourth determination unit which determines whether or not the number of blinks of the right eye or the number of blinks of the left eye measured by the second number-of-blinks measurement unit is equal to or greater than a predetermined number of times; and
a third correction unit which, when the fourth determination unit determines that the number of blinks of the left eye or the number of blinks of the right eye is equal to or greater than the predetermined number of times, if the number of blinks of one of the left and right eyes is greater than the number of blinks of the other eye, corrects the parallax amount determined by the parallax amount determination unit so as to increase the parallax amount, and if the number of blinks of the other eye is greater than the number of blinks of the one eye, corrects the parallax amount determined by the parallax amount determination unit so as to decrease the parallax amount.

10. The device according to claim 2, further comprising:
a second number-of-blinks measurement unit which measures the number of blinks of each of the left and right eyes of the viewer;
a fourth determination unit which determines whether or not the number of blinks of the right eye or the number of blinks of the left eye measured by the second number-of-blinks measurement unit is equal to or greater than a predetermined number of times; and
a third correction unit which, when the fourth determination unit determines that the number of blinks of the left eye or the number of blinks of the right eye is equal to or greater than the predetermined number of times, if the number of blinks of one of the left and right eyes is greater than the number of blinks of the other eye, corrects the parallax amount determined by the parallax amount determination unit so as to increase the parallax amount, and if the number of blinks of the other eye is greater than the number of blinks of the one eye, corrects the parallax amount determined by the parallax amount determination unit so as to decrease the parallax amount.

11. The device according to claim 3, further comprising:
a viewer presence/absence determination unit which determines whether or not the viewer whose center-to-center distance is stored as the determination result of the first determination unit disappears from the front of the display screen of the stereoscopic image display apparatus; and
a fifth determination unit which, when the viewer presence/absence determination unit determines that the viewer disappears from the front of the display screen of the stereoscopic image display apparatus, determines whether to determine the parallax amount by using the shortest distance from among the distances to another viewer other than the viewer who disappears from the display screen of the stereoscopic image display apparatus or to determine the parallax amount by using an average distance of the distances to another viewer other than the viewer who disappears from the display screen of the stereoscopic image display apparatus,
wherein the parallax amount determination unit determines the parallax amount from the shortest distance to the viewer measured by the distance measurement unit and the center-to-center distance measured by the center-to-center distance measurement unit for the viewer at the shortest distance when the fifth determination unit determines to determine the parallax amount by using the shortest distance and determines the parallax amount from the average distance to another viewer calculated by the average distance calculation unit and a predetermined center-to-center distance when the fifth determination unit determines to determine the parallax amount by using the average distance.

12. The device according to claim 4, further comprising:
a viewer presence/absence determination unit which determines whether or not the viewer whose center-to-center distance is stored as the determination result of the first determination unit disappears from the front of the display screen of the stereoscopic image display apparatus; and
a fifth determination unit which, when the viewer presence/absence determination unit determines that the viewer disappears from the front of the display screen of the stereoscopic image display apparatus, determines whether to determine the parallax amount by using the shortest distance from among the distances to another viewer other than the viewer who disappears from the display screen of the stereoscopic image display apparatus or to determine the parallax amount by using an average distance of the distances to another viewer other than the viewer who disappears from the display screen of the stereoscopic image display apparatus,
wherein the parallax amount determination unit determines the parallax amount from the shortest distance to the viewer measured by the distance measurement unit and the center-to-center distance measured by the center-to-center distance measurement unit for the viewer at the shortest distance when the fifth determination unit determines to determine the parallax amount by using the shortest distance and determines the parallax amount from the average distance to another viewer calculated by the average distance calculation unit and a predetermined center-to-center distance when the fifth determination unit determines to determine the parallax amount by using the average distance.

13. The device according to claim 1, further comprising:
a parallax amount switching unit which switches the parallax amount of the stereoscopic image to the determined parallax amount in synchronization with a timing for switching contents displayed on the display screen of the stereoscopic image display apparatus.

14. The device according to claim 2, further comprising:
a parallax amount switching unit which switches the parallax amount of the stereoscopic image to the determined parallax amount in synchronization with a timing for switching contents displayed on the display screen of the stereoscopic image display apparatus.

15. An operation control method of a parallax amount determination device which determines a parallax amount of a stereoscopic image display apparatus which displays a stereoscopic image, the method comprising the steps of:
causing an iris imaging unit to capture an image of an iris of a viewer of a stereoscopic image and to output iris image data representing an iris image;
causing a viewer determination unit to determine a viewer of the stereoscopic image from iris authentication information of a storage device, in which user information, iris authentication information, and the center-to-center distance between the center of a left eye and the center of a right eye are stored in association with each other, on the basis of iris image data output from the iris imaging unit;
causing a distance measurement unit to determine the distance from the display screen of the stereoscopic image display apparatus to the viewer;
causing a center-to-center distance measurement unit to measure the center-to-center distance of the viewer;
causing a determination unit to determine whether or not the center-to-center distance of the viewer is stored in the storage device on the basis of an iris image represented by iris image data output from the iris imaging unit;
causing a center-to-center distance reading unit to read the center-to-center distance of the viewer determined by the viewer determination unit from the storage device when the first determination unit determines that the center-to-center distance of the viewer is stored in the storage device; and
causing a parallax amount determination unit to determine a parallax amount from the display screen size of the stereoscopic image display apparatus, the distance to the viewer measured by the distance measurement unit, and the center-to-center distance read by the center-to-center distance reading unit or when the first determination unit determines that the center-to-center distance of the viewer is not stored in the storage device, to determine a parallax amount from the display screen size of the stereoscopic image display apparatus, the shortest distance from among the distances to the viewer measured by the distance measurement unit, and the center-to-center distance measured by the center-to-center distance measurement unit for the viewer at the shortest distance.
